(19) United States
(12) Patent Application Publication
(10) Pub. No.: US 2025/0341988 A1
(43) Pub. Date: Nov. 6, 2025

(54) A PRINTING SYSTEM, A COPYING SYSTEM, A METHOD OF PRINTING AND A METHOD OF COPYING

(71) Applicant: NT-ware Systemprogrammierungs-GmbH, Bad Iburg (DE)

(72) Inventor: Matthias Budke, Wallenhorst (DE)

(21) Appl. No.: 19/143,741

(22) PCT Filed: Dec. 21, 2023
(86) PCT No.: PCT/EP2023/087499

§ 371 Date: Jun. 26, 2025

(30) Foreign Application Priority Data
Dec. 29, 2022 (GB) 2219804.8

(51) Int. Cl. G06F 3/12; B41J 29/393; G03G 15/00; H04N 1/00; H04N 1/32; H04N 1/34

(52) U.S. Cl. CPC G06F 3/1204; G06F 3/1254; H04N 1/00244; H04N 1/32545; H04N 1/344; B41J 29/393; G03G 15/5087; G03G 15/5091; G06F 3/1288; G06F 3/1292

(57) ABSTRACT

A printing system includes a cloud service configured to manage a first cloud service account and a second cloud service account, a printing apparatus connected to the cloud service and registered with the first cloud service account, and a mobile device connected to the cloud service and controlled by a user registered with the second cloud service account. The mobile device is configured to send print information to the cloud service in accordance with a print instruction for printing a document received from the user using the mobile device. The cloud service is configured create a print job from the print information received from the mobile device, and based on account information associated with the first cloud service account and the second cloud service account, determine whether to send the print job to the printing apparatus for printing.

### TECHNICAL FIELD

The present invention relates to a printing system, a copying system, a method of printing and a method of copying.

### BACKGROUND OF THE INVENTION

It is known that multiple printers, or more typically multifunctional apparatuses or multifunction peripheral devices (MFP's), can be managed using a print server. The print server may be installed within an internal network of a company or organization. When printing is instructed by a user operating a computer, print data is transmitted from the computer to the print server and spooled therein. Then, when printing is instructed by the user operating a desired MFP, the spooled print data is transmitted from the print server to the desired MFP, and printing is performed.

A more recent trend is to move services that have been provided by local servers to the “cloud”. Such services are typically accessed via the internet, and this is referred to as a cloud service. The cloud service can be considered a virtual server, due to the server functionality in fact being provided by any one of a plurality of online servers. Such a plurality of online servers is often referred to as a cloud, due to being located externally and remotely from the network. Thus, it is appropriate in this context to refer to an MFP being configured to exchange information with a cloud service. A cloud service can also be considered as a software (application) platform that provides an abstraction layer on top of the server (physical or virtual) layer. This is often referred to as true cloud (rather than hosted or virtualised servers). True cloud software is written to run on the platform and request, or release, resources as required. Existing or traditional server-based software is able to run on hosted, or virtualised, servers but are bound by the limits of resources of each individual server(s) often resulting in the requirement to manage multiple servers.

Typically, a company or an organization will have one or more MFP's that a user, that works for the company or an organization, can use while at the premises of the company or organization. For example, an office of a company may include a number of MFP's connected to a cloud service, and while an employee is located within the office they may print to any one of the MFP's via the cloud service. In such a case the user/employee is registered with the cloud service account belonging to the company.

However, in the conventional cloud service arrangement discussed above, when a user moves to a different location, for example a different office or visits a hotel or a shop, etc., they are not registered with the cloud service account for that location. This means the user/employee finds it difficult to print or scan/copy any document on an MFP located at the different location.

### SUMMARY OF THE INVENTION

According to a first aspect of the present invention a printing system is provided as set out in claims 1 to 5.

According to a second aspect of the present invention a copying system is provided as set out in claims 6 to 10.

According to a third aspect of the present invention a printing method is provided as set out in claims 11 and 12.

According to a fourth aspect of the present invention a copying method is provided as set out in claims 13 and 14.

### BRIEF DESCRIPTION OF THE DRAWINGS

Embodiments of the present invention will now be described, by way of example only, with reference to the accompanying figures.

FIG. 1 illustrates an example of a printing/copying system.

FIG. 2 illustrates an example of a hardware configuration of a mobile device.

FIG. 3 illustrates an example of a hardware configuration of a multifunction peripheral.

FIG. 4 illustrates an example of the services available on a cloud service.

FIG. 5 illustrates an example of the print as service information.

FIG. 6 is a sequence diagram showing a process flow for printing.

FIG. 7 is a sequence diagram showing a process flow for copying.

### DESCRIPTION OF THE EMBODIMENTS

Each of the embodiments of the present invention described below can be implemented solely or as a combination of a plurality of the embodiments or features thereof where necessary or where the combination of elements or features from individual embodiments in a single embodiment is beneficial.

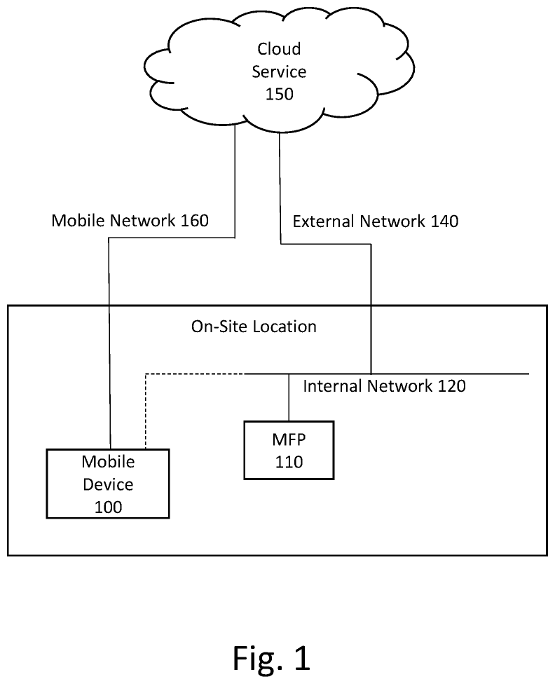

FIG. 1 illustrates a printing/copying system provided for an on-site location. Examples of an on-site location include an office, a school, a shop, a library, a railway station, a hotel, etc. This list is not exhaustive, the on-site location may be anywhere where a printing system is desired.

In the on-site location an MFP 110 is connected to a cloud service 150 via an internal network 120 and an external network 140. The MFP 110 may be considered as a printing apparatus and/or a copying apparatus, or as a multifunctional apparatus. The MFP 110, instead of being a multifunctional apparatus, may be a single functional device that, for example, prints only, copies only, or scans only. A mobile device 100 is also located within the on-site location, and this is connected to, and can communicate with, the cloud service 150 via a mobile network 160. The mobile network 160 is typically wireless internet (e.g. 4G or 5G), but any suitable communication protocol could be used in other embodiments. In an alternative embodiment, the mobile device 100 is not connected to the cloud service 150 via mobile network 160, but is connected to the cloud service 150 via the internal network 120 (shown in FIG. 1 by the dashed line).

The internal network 120 can be a wired network or a wireless network, and it can be simply called a “network” or a Local Area Network (LAN). The external network 140 is typically the internet. The internal network 120 and external network 140 may be connected via a router (not shown).

In FIG. 1 a single MFP 110 is shown, but the on-site location may include a plurality of MFP's 110.

The mobile device 100 is an example of an information processing apparatus such as a mobile telephone. Other suitable mobile devices 100 include tablet computers, laptop computers (PC's) and any other types of handheld computers.

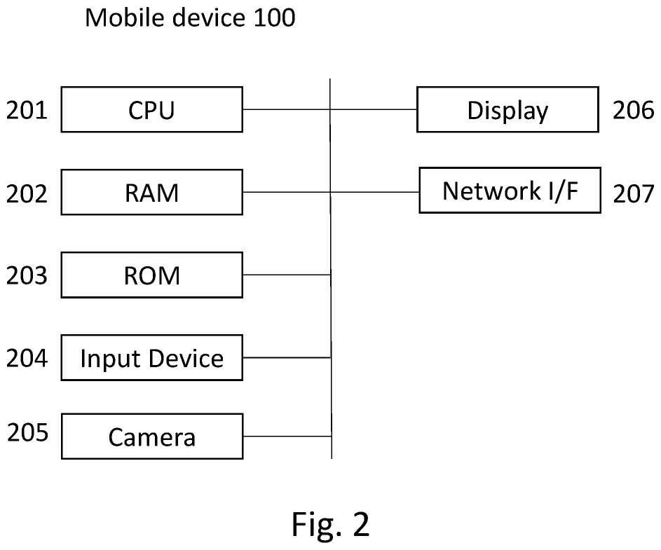

FIG. 2 shows selected standard components that may be present in mobile device 100. The mobile device 100 has for example a CPU (Central Processing Unit) 201, a RAM (Random Access Memory) 202, a ROM (Read Only Memory) 203, an input device 204, a camera 205, a display unit 206, and a network interface 207 which are all connected to each other via a bus. It is not necessary that all the components shown in FIG. 2 are present in the mobile device 100 (for example, the ROM 203 may be a software ROM).

The CPU 201 is a standard processor such as those available from Intel (RTM), ARM (RTM), or AMD (RTM). The RAM 202 is a conventional RAM and is used as a temporary storage area for instructions being processed by the CPU 201. The ROM 203 is a memory that stores certain applications for use by the mobile device 100. The input device 204 includes any conventional means of inputting information to the mobile device. Such an input device 204 is typically a touch screen and/or touch pad (working together with the display 206). The input device 204 may include other means of input such as physical buttons or a keyboard. Voice recognition may also be used as an input device. The display unit 206 is a TFT display for providing output display for a user. Network interface 207 is a set of standard components that allows the mobile device 100 to communicate over wireless networks.

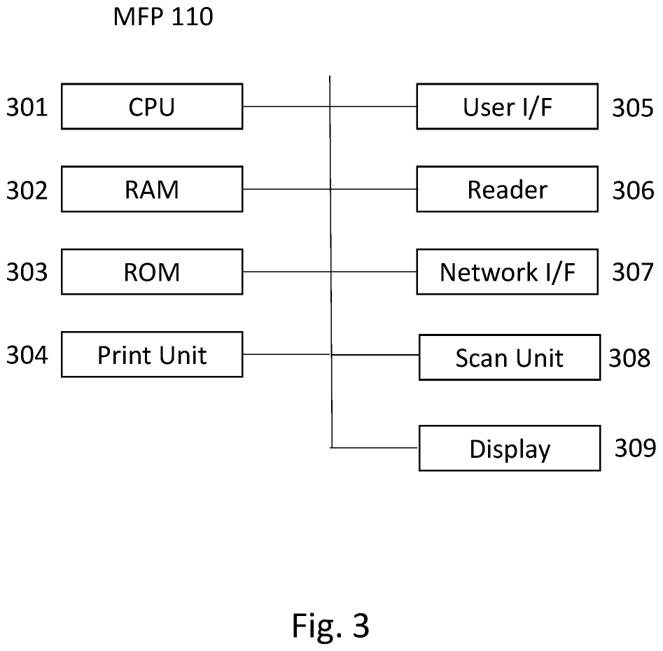

FIG. 3 shows selected standard components that are present in the MFP 110. The MFP 110 has a CPU 301, a RAM 302, a ROM 303, a print unit 304, a user input/output 305, a card reader 306, a network interface 307, a scan unit 308, and a display 309 which are all connected to each other via a bus.

The CPU 301 is a standard processor such as those available from Intel (RTM) or AMD (RTM). The RAM 302 is a conventional RAM and is used as a temporary storage area for instructions being processed by the CPU 301. The ROM 303 is a memory that stores certain applications for use by the MFP 110, such as the BIOS. The CPU 301 comprises a user interface generation unit that generates the user interface, which is then displayed by the display 309 of the MFP 110.

The print unit 304 could be implemented by an electrophotographic type printer engine or an inkjet type printer engine, and it can print an image on a printing media such as paper based on the provided data. The scan unit 308 comprises hardware configured to capture the image of a document to be scanned.

The user input/output 305 includes a plurality of hardware buttons and software buttons which the user can select to provide input to the MFP 110. The user input/output 305 may include a touch screen as part of the display 309, and/or a keyboard which can be used to enter alphanumeric text. The display 309 includes a LCD display, together with touch sensors which provide touch screen functionality.

The reader 306 reads out user information from a device personal to a user. The readout information is used to identify or authenticate a user who wishes to operate the MFP 110. The personal device could be a contactless card or a mobile device that includes the correct communication protocols to communicate with reader 306. The user information can be input into the MFP 110 by using a keyboard instead of the reader 306.

Network interface 307 is a set of standard components that allows the MFP 110 to communicate over the internal network 120. Thus, the network interface 307 comprises an input unit and an output unit, which can be used by the MFP 110 to communicate with the cloud service 150.

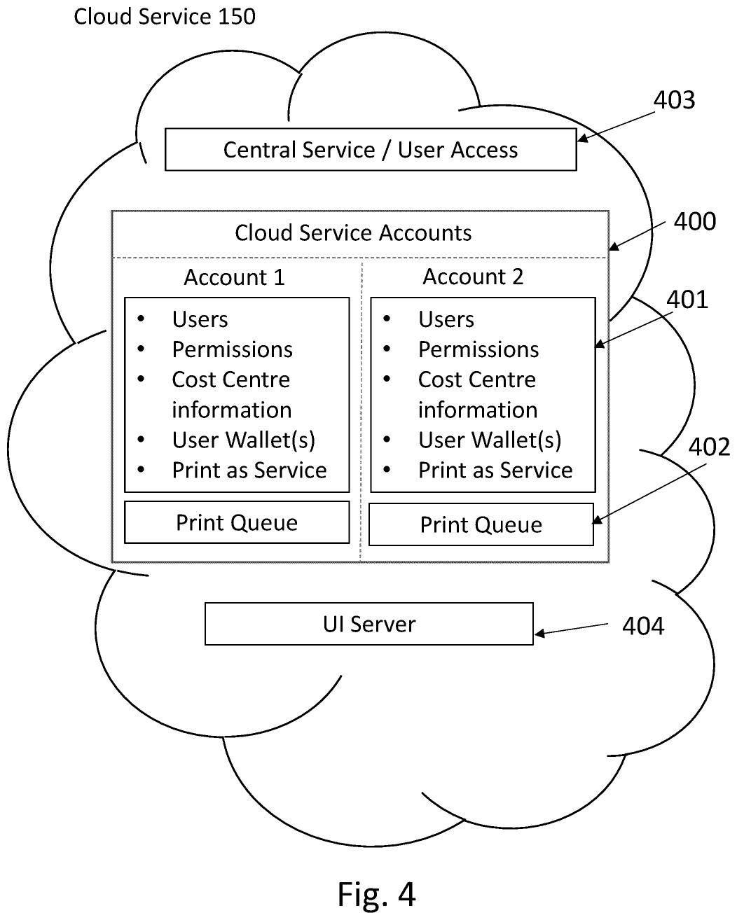

FIG. 4 illustrates an example of the functions available on the cloud service 150. The cloud service 150 may be considered as a type of “server”. In this application, “server” includes a physical server, an application server, a cloud service provided on hosted or virtualised servers, or a true cloud service. The functions on the cloud service 150 are typically provided by software applications running on one or more servers.

The cloud service 150 holds cloud service account information 400 that belongs to each company or organisation that has an account with the cloud service 150. The cloud service account information may be considered as “tenant” information, where each tenant is a company or organisation.

For each cloud service account, the cloud service account information 400 contains information 401 that includes the identities of registered users for that cloud service account. The idea of registered users in a print and copying system is known in the print and copying field and consists of those users who are registered within an authentication function of the system. The registered users may have differing authorisations, e.g. permission to print, copy or perform other operations within the system. Not all users may have the same permissions. A registered user may log in to the cloud service 150 and update and change their account details. An administrator may log in to the cloud service 150, and the administrator may have permission to access, amend, and otherwise change one or more user accounts. Changes made by an administrator to permissions or to add/remove registered users are kept up to date in the cloud service 150.

In addition to the identity of the registered users, permissions of the users (e.g. print and copying permissions such as printing single/duplex or the ability to print colour/black and white), information about the print history of the user (e.g. volumes printed by the user etc.), cost centre information (cost centre information allocated by a user against certain print or copy/scan activities), and information on a user's wallets, may be recorded. The information 401 also stores print as service information that includes information on whether “print as service” (described in more detail below) is enabled for each cloud service account and/or whether “print as service” is enabled for each user of a cloud service account.

The cloud service account information 400 further includes a print queue 402 for storing print jobs for printing for each of the cloud service accounts. In other words, each cloud service account (tenant) has its own print queue.

In the present embodiments, a user wallet is a virtual “wallet” or virtual “purse” assigned to each user that holds a user's allocated funds/money or credit for printing/copying. For example, the user's wallet may hold a fund/credit of £10, and each time a user prints a document, or copies a document, the funds/credit in the wallet is deducted. Once a user's wallet is empty, the user will not be able to print or copy any document. The funds/credit in the wallet may be money or may be some kind of “credit token”. Furthermore, the funds/credit may instead of representing money, may be a “number of pages”. If “number of pages” is used, then there may need to be a way of differentiating between printing/copying black and white or colour documents. For example, one page of colour printing/copying may be considered to be equivalent to two pages of black and white printing/copying. One or more wallets may be provided for each user.

A central service and user access function 403 on the cloud service 150 is configured to provide configuration information for the MFP 110 and/or mobile device 100, and a user access function. When a request is received from a mobile device 100 or MFP 110 to access the cloud service 150, the user access function 403 checks the received user name and password or other authentication information such as a token against a database of registered users and only allows access to further functions of the cloud service 150 if the user name and authentication match a registered user.

The cloud service 150 also has a user interface (UI) server function 404 and the MFP 110 may be configured to be served UI pages from the cloud service 150.

The embodiments described herein provides an arrangement where a user that is registered with one (a first) cloud service account can use another (a second) cloud service account, that they are not registered with, to print and/or scan a document at an MFP 110 that is registered for use with the another (second) cloud service account. For example, as shown in FIG. 1, consider a case where a user of the mobile device 100 is registered with a first cloud service account on the cloud service 150, and the company or organization that is located in the on-site location is registered with a second cloud service account on the cloud service 150. In this case, the user of mobile device 100 may work for company A and is visiting the on-site location of company B. The embodiment described herein allows the user of mobile device 100 to print, or copy/scan, documents using the MFP 110 belonging to company B located at the on-site location, even though the user of the mobile device 100 is not employed by company B and is not registered with the second cloud service account. Such a concept is referred to as “print as service” herein. In the embodiments described, a user that is not registered with a particular cloud service account (but is registered with another cloud service account) is referred to as an “external user”. In the above example, the user of the mobile device 100 is considered an external user by the second cloud service when they are at the on-site location that belongs to company B. A user that is registered with a particular cloud service account is called an “internal user”.

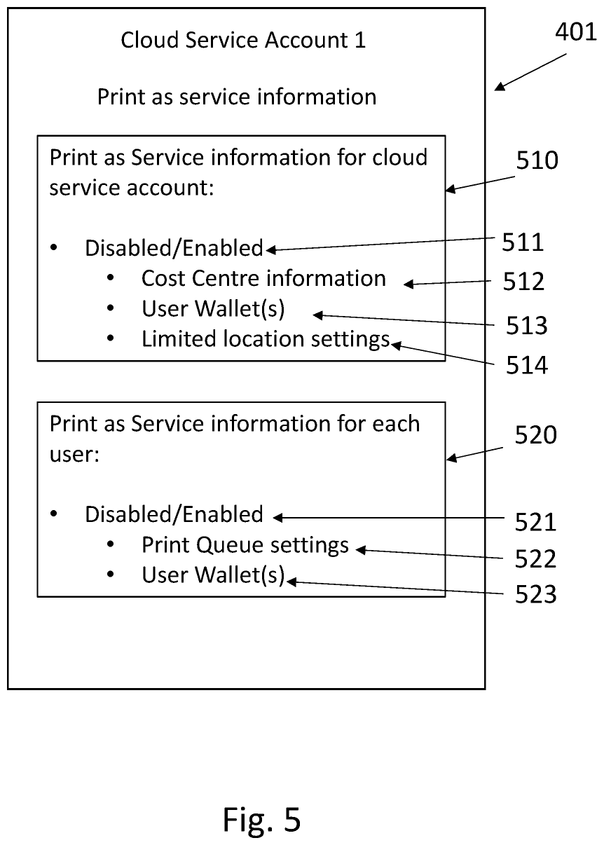

FIG. 5 shows an example of the print as service information included in the information 401 that is set for each cloud service account. A first cloud service account is shown in FIG. 5, but the information will be set for each cloud service account on the cloud service 150.

The information 401 includes first print as service information 510 for to the cloud service account, and second print as service information 520 for each user. The first print as service information 510 and second print as service information 520 is typically set by an administrator of each cloud service account (e.g. an administrator for each company or organization).

The first print as service information 510 includes a setting 511 as to whether print as service is disabled or enabled for the cloud service account, cost centre information 212 as to a cost centre for print/copy jobs performed using print as service, settings 513 relating to user's wallets, and settings 514 related to limiting print as service to a particular location and/or MFP. If print as service is disabled then external users cannot use the cloud service account to print and/or copy at any MFP. If print as service is enabled, then external users (assuming they have been enabled for print as service by their administrator) can use the cloud service to print and/or copy in accordance with remaining part of the first print as service information 510.

The cost centre information 512 includes pricing details for each print and/or scan job that can be performed by an “external user”. For example, an administrator will set a price “profile”, or cost, for a print job, or copy job, for an external user. Such a price profile will typically be different to that for an internal user (i.e. a user that is registered with the cloud service account). The price profile may set a cost as a monetary charge (e.g. £ or $) per sheet, or may be number of sheets.

The user wallet settings 513 will define a global wallet that all external print jobs, or copy jobs, are charged against/from for each user. The user wallet settings 513 may allow internal users to use the global wallet, and may define a preferred order in which funds are charged against/from. For example, for internal users a preferred order may be a “primary” wallet and then the global wallet. The global wallet's allocated funds/money or credit for printing/copying is managed by a user, and the administrator of the cloud service account has no control over the funds available. A user can typically add funds (“top-up”) through conventional web-based applications such as PayPal (RTM), or by credit card etc. Any suitable payment method may be used. Typically, the user can add funds using an application installed and running on the mobile device 100.

The limited location settings 514 relates to limiting print as service to a particular location and/or MFP. The settings can be set by an administrator such that only one MFP or a selection of MFP's can be used by an external user. For example, a company or organisation may have a number of MFP's located within their office that are all accessible by its employees (internal users), but it may be desired to only allow external users to use a single MFP located with a reception area of the office. Alternatively, in this example, it may be decided that all MFP's located on a particular part of an office (reception, ground floor etc.) may be useable by an external user.

The second print as service information 520 includes a setting 521 as to whether print as service is disabled or enabled for each user, information 522 as to print queue settings, and settings 523 related to a user's wallet(s). If print as service is disabled for a user, then a user cannot use a cloud service account that they are not registered with to print and/or copy. If print as service is enabled, then a user can use the cloud service account (assuming that the cloud service account has been enabled for print as service) that they are not registered with to print and/or copy. In other words, if print as service is enabled a user is allowed to use a second, or “external”, cloud service account.

The print queue information 522 is set for each user such that for any print job, print job data and attribute information about the print job are stored in the print queue 402 of the cloud service account on the cloud service 150. Thus, even if a user is using a mobile device 100 that is capable to storing print jobs in a print queue located on the mobile device 100, when print as a service is enabled for a user, all print jobs for the user will be stored on the print queue 402 in the cloud service 150 for that user.

The user wallet settings 523 includes details of the global wallet assigned to the user. As noted above, the global wallet's allocated funds/money or credit for printing/copying is managed by a user. The administrator of the cloud service account has no control over the funds available in the global wallet. A user can typically add funds (“top-up”) through conventional web-based applications such as PayPal®, or by credit card etc. Any suitable payment method may be used. Typically, the user can add funds using an application installed on the mobile device 100.

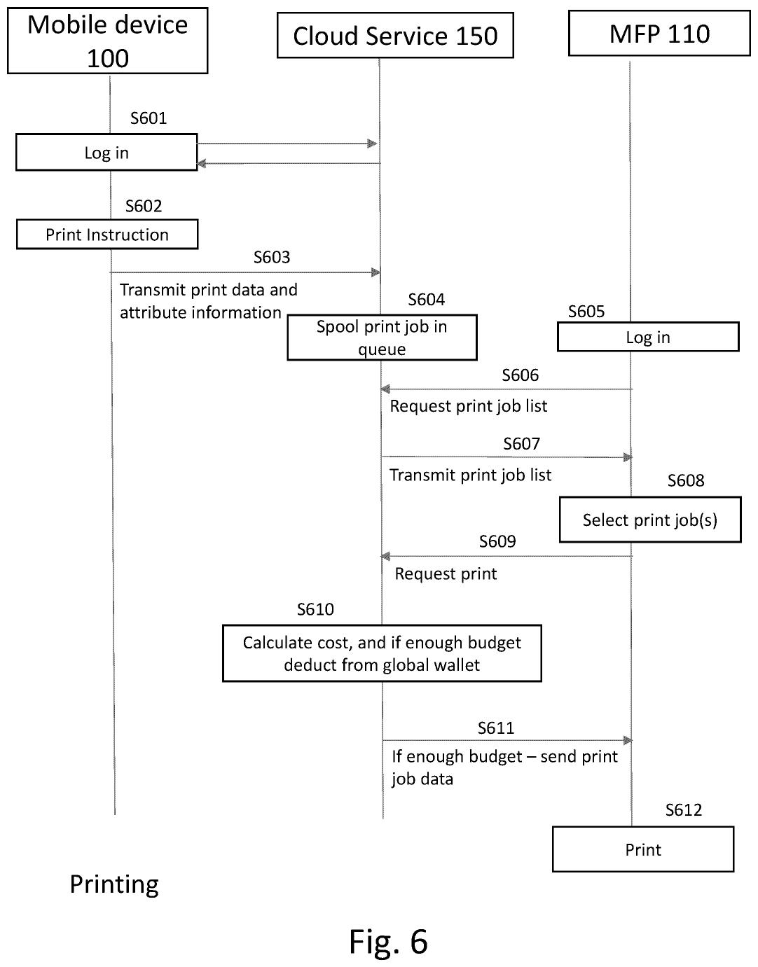

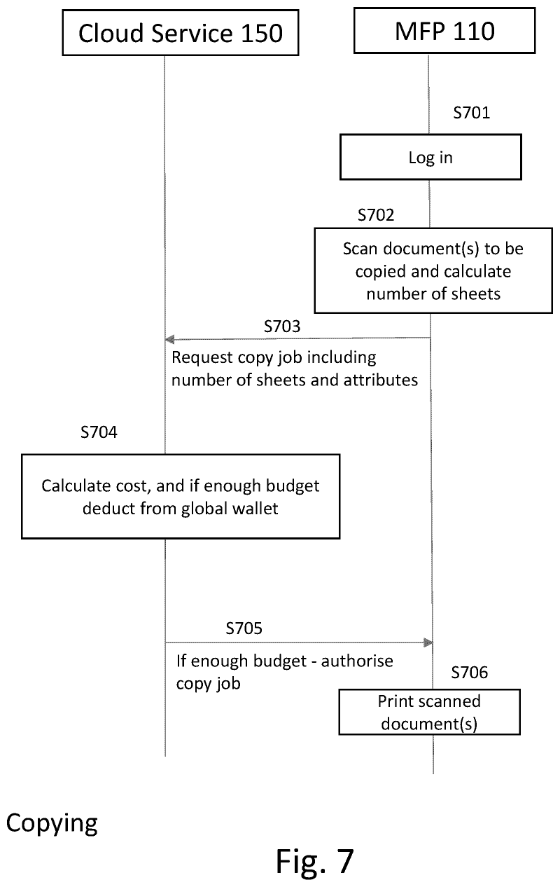

The embodiments will now be described by way of print and copy/scan workflows. The skilled person will understand that the print and copy/scan workflows described below with reference to FIGS. 6 to 7 are illustrative, and the print and/or copy workflows may be varied according to needs.

FIG. 6 shows a sequence diagram illustrating a printing method. In FIG. 6 the MFP 110 is located in an on-site location. In step S601, the user of the mobile device 100, using an application installed and running on the mobile device 100 requests to log in to the cloud service 150. As shown in FIG. 1, the mobile device 100 is able to communicate with the cloud service 150 using a mobile network (for example 4G or 5G). Alternatively, if the owners of the on-site location allow, the mobile device 100 may communicate with the cloud service 150 via the internal network 120 and external network (for example using Wi-Fi®). In order to log in to the cloud service 150 the user provides their user credentials, such as under name (ID) and password. As an alternative, the mobile device 100 may include some form of biometric reader (e.g. fingerprint scanner) to allow the user's identity to checked. The mobile device 100 sends an access request to the cloud service 150. The access request includes user identification and authentication information which is processed by the user access function 403 of the cloud service 150. The user access function 403 checks the received identification and authentication information. If the information corresponds to that of a registered user, the access request is successful. The user access function 403 also checks the second print as service information 520 to determine whether print as service is enabled for the user. If print as service is enabled for the user, the application running on the mobile device 100 may indicate to the user that they are able to print/scan using cloud service accounts that they are not registered with (i.e. an external cloud service account).

Once a user has generated, or otherwise obtained, a document to print, in step S602 the user instructs to print data. This instruction can be issued by an editing program installed in the mobile device 100. Such an application includes but is not limited to a word processing application, spreadsheet software, picture editing software and a web browser. The document that the user wishes to be printed may be stored on the mobile device 100, or stored on a cloud-based storage system that the mobile device 100 (or cloud service 150) has access to.

The instruction to print may be issued by the application running on the mobile device 100.

In step S603 print data and attribute information relating to the document/data to be printed is transmitted from the mobile device 100 to the cloud service 150. In step S604, the transmitted print data and attribute information is used by the cloud service 150 to create a print job and this is then spooled and stored in the print queue 402 for the cloud service registered with the user on the cloud service 150. The attribute information may include information such as the identity of the user who requested the printing and information about print settings, such as number of pages, number of copies, black and white or colour printing, duplex printing, paper/media type, paper size, stapling options, finishing etc. The attribute information may include any information that is related to a user and/or print data. Once a print job is spooled and stored in the print queue 402 of the cloud service 150 an application running on the mobile device 100 may indicate to the user that their print job is ready for printing at an available MFP and/or external cloud service account. In an alternative embodiment, the print job created by the cloud service 150 may be spooled and stored in the print queue 402 for the cloud service registered with the on-site location cloud service 150. In a further alternative embodiment, the cloud service 150 may include a global print queue that is not registered with only a single cloud service account, but allows storage of print jobs for any user using print as service. In other words, the global print queue may be a specifically provided print queue for use with print as service.

Once the user's print job is spooled and ready for printing, the user logs into the MFP 110. There are a number of ways that this can be achieved. One way is for the mobile application running on the mobile device to use near field communication using network interface 207 to communicate with the reader 306 of the MFP 110 to make an access request to the external cloud service account. By using this communication path, the mobile application on the mobile device 100 provides the MFP 110 with information necessary to identify the user (i.e. a certificate, number or identifier related to the user's user account) and as part of the access request the MFP 110 then sends this information to the user access function 403 of the cloud service 150. Another way of using near field communication with network interface 207 and the reader 306 of the MFP 110, is for the MFP 110 to identify itself, and the external cloud service account, to the mobile application running on the mobile device 100, and for the mobile device 100 to communicate with the cloud service 150 via mobile network 160 or internal network 120 to allow the user access to the MFP 110. If the mobile device is not capable of near field communication, or there are any other reasons that mean near field communication cannot be performed, then another way for the user to log into MFP 110 is for the MFP 110 to display information that can be either entered into the mobile application running on the mobile device 100 by the user, or the information can be displayed on the display 309 of the MFP 110 in such a manner that the information can be read from an image of the display 309 captured by the camera 205 of the mobile device 100. For example, the MFP 110 may display a barcode or QR-code on display 309 that encapsulates the necessary information, and the application running on the mobile device 100 includes the software to read/decode the barcode/QR-code once it is recorded as an image by the camera 205 of the mobile device 100. Once the image is captured and read by the application running on the mobile device, it then communicates with the cloud service 150 as described above to allow the user to access the MFP. As described above, there are a number of methods for allowing a user to access the MFP 110 using the application running on the mobile device 100. The embodiment is not limited to the method described above. Any suitable communication method between the application running on the mobile device 100 and the MFP 110 may be used. In other words, any way of using an application running on the mobile device 100 that authenticates a user to the cloud service 150, and the cloud service 150 then authorises the user to use the MFP 110 may be used. Other suitable ways of logging in may be used.

As part of the process of logging a user in to use the MFP 110, the cloud user access function 403 of the cloud service 150 checks the first print as service information 510 of the cloud service account of the MFP 110 to determine whether print as service is enabled (i.e. to determine whether the external user can log in to the MFP 110). If print as service is not enabled the user will be notified that they are not able to log into the MFP 110 and they will not be able to use the functions available on the MFP 110.

Once the user has successfully logged into the MFP 110 (i.e. the authentication of the user was successful and both the user and the cloud service account of the MFP 110 are enabled for print as service), the user is allowed to use the functions of the MFP 110. One of the functions of the MFP 110 is “print”, and when the user selects “print”, in step S606 the MFP 110 requests the cloud service 150 for a list of the print jobs stored in the print queue 402 of the user in the cloud service registered with the user. This list contains the names of print jobs having attribute information indicating that the cloud service 150 received the print job data and attribute information from the logged in user. In an alternative embodiment where the print jobs of the user are stored on the print queue registered with the cloud service of the on-site location, the print jobs are requested by the MFP 110 from this print queue 402. In a further alternative embodiment, the print jobs are requested for the user from the global print queue.

In step S607, the requested list of print jobs is transmitted from the cloud service to the MFP 110. In step S608, the print job list provided by the cloud service 150 is displayed on the display screen 309 of the MFP 110. The names of print jobs are displayed on the display screen 309 so that the user can easily select a print job which he or she wishes to print.

In step S608, the user selects a print job using the user interface 305, and in step S609, the MFP 110 sends a request to the cloud service 150 to print the selected print job. In step S608 the user may select one or more print jobs from the displayed print job list. If the user selects more than one print job, in step S609 the MFP 110 sends a request to the cloud service 150 for printing each of selected print jobs separately.

In step S610 the cloud service 150 calculates the cost of the selected print job using the cost centre information 512 associated with the cloud service registered for the on-site location. For example, the cloud service 150 may calculate the cost based on the number of pages to be printed and on attributes such as colour or black and white printing. Any suitable method of calculating the print job cost may be used. The calculated print job cost may be a “monetary value” (for example a currency (e.g. “£”)), a “token value”, or it may be the number of pages to be printed. If more than one print job has been selected by the user, then the cloud service 150 calculates the cost of each selected print job separately and in turn. If the calculated print job cost is the number of pages to be printed, then it may be desired to consider the difference in cost between black and white printing and colour printing. This could be achieved by counting one page of colour printing as being equivalent to two-pages of black and white printing. Of course, it is not limited to this ratio of 1:2 (B+W/colour), any suitable ratio may be used.

It is not always necessary for the cloud service 150 to calculate the print job cost, in some arrangements it may be preferable for the MFP 110 to calculate the print job cost. The MFP 110 may calculate the print job cost in a similar manner to the cloud service 150. In this case, the calculated print job cost is sent by the MFP 110 to the cloud service 150 at the same time as sending the requested print job in step S609.

In step S610 the cloud service 150 compares the calculated print cost to the user's budget available in the user's global wallet, to determine whether the user has enough funds/credit for the selected print job.

If the user does have enough funds/credit for the selected print job, in step S611, the cloud service 150 authorises the print job, sends the print data for the specific print job from the print job queue in the cloud service 150, and removes the appropriate funds from the user's global wallet.

If more than one print job has been selected by the user, the cloud service 150 determines whether each of the selected print jobs is authorised separately and in turn. If a first print job is authorised, in step S611 the cloud service 150 authorises that print job, sends the print data for that specific print job from the print job queue in the cloud service 150, and removes the appropriate funds from the user's global wallet for that specific print job. The MFP 110 then sends a request to the cloud service 150 for the second print job, and this is repeated for all the selected print jobs. In this manner, steps S609 to S611 are repeated until all the selected print jobs are dealt with.

Step S611 may include converting, by the cloud service 150, the print data from a generic PCL file format in which it was sent to the queue 402 by the mobile device 100 into a print language that is accepted by the MFP 110. This conversion is performed by means of device information files (DIF files) stored on the cloud service.

In step S612, printing is performed at the printer unit 304 of the MFP 110 based on print job data received from the cloud service 150.

After the printing of the print job is performed, the cloud service 150 may send an enquiry to the MFP 110 to check if the printing was successful (not shown in FIG. 6). For example, there may have been a paper jam, network issue or power failure before the print job could be completed, and it would not be desirable to charge a user for any such errors. If such an error occurred during the printing of the print job, typically the cloud service 150 will refund an appropriate amount to the user's global wallet (e.g. the cost of any pages that were not printed). Alternatively, or in addition, the cloud service 150 may authorise the complete reprinting, or partial reprinting (i.e. the number of missing pages), of the print job. Instead of the cloud service 150 sending an enquiry to the MFP 110, the MFP 110 may send an acknowledgement, or completion report, to the cloud service 150 each time a print job is complete, so that the cloud service 150 may determine whether the print job, or print jobs, were correctly printed.

Although not shown in FIG. 6, if in step S610 it is determined that the user does not have enough funds for the selected print job, the user is not authorised to print the print job, and the cloud service 150 does not send the authorisation notification (S611) and/or the print data to the MFP 110, nor are any fees removed from the user's global wallet. In this case the cloud service 150 may send an instruction to the MFP 110 to display an error message such as a message informing the user that they do not have enough funds for the selected print job. Alternatively, the cloud service 150 may simply send a notification to the MFP 110 that the print job is not authorised, and the MFP 110 may generate the error message to be displayed to the user based on the operating system 501 and/or the application 502. If more than one print job has been selected by the user, and the user has enough funds for some but not all the selected print jobs, because the selected print jobs are dealt with individually, the cloud service 150 will authorise each print job in turn until the user does not have enough funds. The user will be informed of the print jobs for which they do not have enough funds.

FIG. 7 shows a sequence diagram illustrating a copying method. In step S701 the user logs into the MFP 110 using the application running on mobile device 100. The method used for log in is the same as described in step S605 of FIG. 6 and so no further description is given to avoid repetition.

Once the user has successfully logged into the MFP 110 (i.e. the authentication of the user was successful and both the cloud service account of the user and the cloud service account of the MFP 110 (on-site location) are enabled for print as service), the user can use one or more of the functions of the MFP 110. One of the functions on the MFP 110 is “copy”, and in step S702 when the user selects “copy”, the MFP 110 instructs the user to scan the document(s) they wish to copy. The user locates the document(s) on to the scan unit 308 of the MFP 110 and instructs the MFP 110 to scan the document(s). The scan unit 308 may include both a “flat bed” scan part for scanning a single page of a document at a time, and a “feed-in” scan part that can scan multiple pages of a document (single sided and/or double sided) at a time. The “flat bed” scan part may be used for copying individual pages from books for example. The MFP 110 stores the image(s) of the scanned document(s) in its memory (e.g. RAM 302) as scanned image data.

Once the scan of the document(s) is complete, the MFP calculates the number of sheets that are to be copied, or in other words the number of sheets that are to be printed by the print unit 304. The MFP 110 also determines the number of copies of the scanned document(s) to be made based on user input. For example, the document to be copied may include five pages and the user may wish to make three copies of the five-page document, and thus fifteen pages in total are to be printed (copied). The MFP 110 also records any attributes of the desired copy entered by the user at the user interface 305. For example, the attributes may indicate whether the copies are to be made in colour or black and white, whether double sided printing is to be performed, the type of paper to be used, and other finishing options. In step S703 the MFP 110 sends a request for the copy job to the cloud service 150, together with the calculated number of sheets (and attributes).

In step S704 the cloud service calculates the cost of the copy job using the cost centre information 512. For example, the cloud service 150 may calculate the cost based on the number of pages to be printed/copied and on attributes such as colour or black and white printing. Any suitable method of calculating the copy job cost may be used. The calculated copy job cost may be a “monetary value” (for example a currency (e.g. “£”)), a “token value”, or it may be the number of pages to be printed. If the calculated copy job cost is the number of pages to be printed/copied, then it may be desired to consider the difference in cost between black and white printing and colour printing. This could be achieved by counting one page of colour printing as being equivalent to two-pages of black and white printing (a B+W/colour ratio of 1:2). Of course, it is not limited to this ratio of 1:2 (B+W/colour), any suitable ratio may be used.

It is not always necessary for the cloud service 150 to calculate the copy job cost, in some arrangements it may be preferable for the MFP 110 to calculate the copy job cost. The MFP 110 may calculate the copy job cost in a similar manner to the cloud service 150. In this case, the calculated copy job cost is sent by the MFP 110 to the cloud service 150 at the same time as sending the requested copy job in step S703.

In step S704 the cloud service compares the calculated copy job cost to the user's budget available in the user's global wallet, to determine whether the user has enough funds/credit for the desired copy job. If the user has enough funds/credit for the copy job, in step S705, the cloud service 150 notifies the MFP 110 that the copy job is authorised and removes the appropriate funds from the user's global wallet. In step S706, the MFP 110 reads out the scanned image data of the document(s) stored in its memory (RAM 302) and sends this to the print unit 304 for printing. Thus, the scanned document(s) is printed/copied. After the scanned document(s) are printed by the print unit 304, the cloud service 150 may send an enquiry to the MFP 110 to check if the copy job was performed successfully (not shown in FIG. 7). For example, there may have been a paper jam, network issue or power failure before the copy job could be completed, and it would not be desirable to remove funds from a user's wallet(s) if there is any such error. If such an error occurred during the printing of the copy job, typically the cloud service 150 will refund an appropriate amount to the user's global wallet (e.g. the cost of any pages that were not printed). Alternatively, or in addition, the cloud service 150 may authorise the complete reprinting, or partial reprinting (i.e. the number of missing pages), of the copy job. Instead of the cloud service 150 sending an enquiry to the MFP 110, the MFP 110 may send an acknowledgement, or completion report, to the cloud service 150 each time a copy job is complete, so that the cloud service 150 may determine whether the copy job was correctly performed.

Although not shown in FIG. 7, if in step S704 it is determined that the user does not have enough funds for the desired copy job, the user is not authorised to complete the copy job, and the cloud service 150 does not send an authorisation to the MFP 110. In this case the cloud service 150 may send an instruction to the MFP 110 to display an error message such as a message informing the user that they do not have enough funds for the copy job. Alternatively, the cloud service 150 may simply send a notification to the MFP 110 that the copy job is not authorised, and the MFP 110 may generate the error message to be displayed to the user based on the operating system 501 and/or the application 502.

As described above, the embodiments allow a user that is registered with one (a first) cloud service account to use another (a second) cloud service account that they are not registered with, to print and/or scan/copy a document at an MFP 110 that is registered for use with the another (second) cloud service account. In other words, once a user is registered (known) with the cloud service 150, they can use their cloud service account to print/copy in any location for which print as service is enabled. This benefits an end user because they can print and/or scan/copy a document using their existing cloud service account at any other enabled cloud service account. They do not need to create or join another account. The user also has use of, and control over, a global wallet assigned to them, and they can use an application running on the mobile device 100 to view and add funds to the global wallet. The user is likely to remember locations where he or she is able to print/copy documents. The application running on the mobile device 100 may show nearby locations (via a map or simply a list) where the user can print/copy (i.e. where print as service is enabled). Thus, the arrangement provides increased user convenience.

The embodiment also provides advantages to the company or organisation that enables print as service. Such advantages include directly receiving money for the use of their MFP's by external users. For example, the cost of printing/copying, or at least a proportion of the cost, that is deducted from a user's global wallet will be paid to the company or organisation (from via the cloud service 150). The company or organisation may also indirectly receive money from external users from increased footfall. For example, in the case of a shop, a user visiting the shop to print a document, while in the shop may take the opportunity of purchasing goods from the shop. In other words, the shop (company or organisation) may benefit from increased throughflow or footfall that they would otherwise not have. Another benefit may be advertisement of the company or organisation in the application running on the mobile device 100.

The embodiments further provide advantages to the cloud service 150. This includes receiving additional money for providing the cloud service. For example, for each print as service printing/copy job performed at the MFP 110, the cloud service may take a certain percentage of the cost charged to the user's global wallet. The cloud service 150 will also gain more exposure to users which may increase sales and desire to use the services of the cloud service 150.

### Other Embodiments

In the above-described embodiments, the mobile device 100 connects to the cloud service account registered with the user in order to send data to be printed to the cloud service 150. However, in an alternative embodiment the mobile device 100 may be able to connect “directly” to the cloud service account registered with the on-site location. In such a case the user access function 403 will check the user account details of the user an allow the user to log into the cloud service account registered with the on-site location as a “guest user”. At the on-site location, details of how a user can login as a guest user may be provided. In this case the print jobs will be created by the cloud service 150 and stored in a print job queue associated with the cloud service registered with the on-site location.

In another alternative embodiment a user may request to print a document using a cloud service account registered with the on-site location (i.e. the cloud service account that the user is not registered with) via email. For example, the on-site location may provide external users with an email they can use if they wish to print documents. Once a user has sent the email with a print request, they will receive an email back from the cloud service 150 that includes a voucher (or token). The user then uses this voucher to log in to the MFP 110 in the on-site location to print their document. For example, the voucher can include information necessary for the user to log into the MFP. The information may include a temporary username and password. The print job may be created and stored in the cloud service account registered to the user, and when the user logs into the MFP 110 using the voucher the print job is sent (or “pushed”) to the MFP 110 registered with the on-site location. Alternatively, the document to be printed could be included in the initial email and the print job created and stored on the cloud service account of the on-site location. The voucher may be time limited such that the user will only be able to use it for a certain amount of time, and once the time is expired, they will not be able to log into the MFP 110.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments.

1. A printing system comprising:
a cloud service configured to manage a first cloud service account and a second cloud service account;
a printing apparatus connected to the cloud service and registered with the first cloud service account; and
a mobile device connected to the cloud service and controlled by a user registered with the second cloud service account,
wherein the mobile device is configured to send print information to the cloud service in accordance with a print instruction for printing a document received from the user using the mobile device, and
wherein the cloud service is configured create a print job from the print information received from the mobile device, and based on account information associated with the first cloud service account and the second cloud service account, determine whether to send the print job to the printing apparatus for printing.

2. The printing system according to claim 1, wherein:
the account information includes first enablement information associated with the first cloud service account and second enablement information associated with the second cloud service account, and
the cloud service is configured to determine whether to send the print job to the printing apparatus based on the first enablement information and second enablement information.

3. The printing system according to claim 2, wherein the first enablement information indicates whether a user that is not registered with the first cloud service account is enabled to use the first cloud service account to print the print job at the printing apparatus.

4. The printing systems according to claim 2, wherein the second enablement information indicates whether the user that is registered with the second cloud service account is enabled to use another cloud service account to print a print job.

5. The printing system according to claim 1, wherein:
the account information further includes information on a global wallet associated with the user, the global wallet representing funds available to the user, and
the cloud service is configured to determine whether to send the print job to the printing apparatus based on the funds available in the global wallet.

6. A copying system comprising:
a cloud service configured to manage a first cloud service account and a second cloud service account;
a copying apparatus connected to the cloud service and registered with the first cloud service account; and
a mobile device connected to the cloud service and controlled by a user registered with the second cloud service account;
wherein the copying device is configured to send a copy job request to the cloud service in accordance with a copy instruction for copying a document received from the user using the copying apparatus, and
the cloud service is configured, based on account information associated with the first cloud service account and the second cloud service account, to determine whether to authorize the copy job at the copying apparatus.

7. The copying system according to claim 6, wherein:
the account information includes first enablement information associated with the first cloud service account and second enablement information associated with the second cloud service account, and
the cloud service is configured to determine whether to authorize the copy job at the copying apparatus based on the first enablement information and the second enablement information.

8. The copying system according to claim 7, wherein the first enablement information indicates whether a user that is not registered with the first cloud service account is enabled to use the first cloud service account to copy the copy job at the copying apparatus.

9. The copying system according to claim 7, wherein the second enablement information indicates whether the user that is registered with the second cloud service account is enabled to use another cloud service account to copy a copy job.

10. The copying system according to claim 6, wherein:
the account information further includes information on a global wallet associated with the user, the global wallet representing funds available to the user, and
cloud service is configured to determine whether to authorise the copy job at the copying apparatus based on the funds available in the global wallet.

11. A printing method in a printing system including a cloud service configured to manage a first cloud service account and a second cloud service account, a printing apparatus connected to the cloud service and registered with the first cloud service account, and a mobile device connected to the cloud service and controlled by a user registered with the second cloud service account, the method comprising:
sending print information to the cloud service in accordance with a print instruction for printing a document received from the user using the mobile device;
creating a print job from the print information received from the mobile device; and
determining whether to send the print job to the printing apparatus for printing based on account information associated with the first cloud service account and the second cloud service account.

12. A printing method according to claim 11, wherein:
the account information includes first enablement information associated with the first cloud service account and second enablement information associated with the second cloud service account, and
the determining determines whether to send the print job to the printing apparatus based on the first enablement information and second enablement information.

13. A copying method in a copying system including a cloud service configured to manage a first cloud service account and a second cloud service account, a copying apparatus connected to the cloud service and registered with the first cloud service account, a mobile device connected to the cloud service and controlled by a user registered with the second cloud service account, the method comprising:
sending a copy job request to the cloud service in accordance with a copy instruction for copying a document received from the user using the copying apparatus; and
determining whether to authorize the copy job at the copying apparatus based on account information associated with the first cloud service account and the second cloud service account.

14. A copying method according to claim 13, wherein:
the account information includes first enablement information associated with the first cloud service account and second enablement information associated with the second cloud service account, and
the determining determines whether to authorize the copy job based on the first enablement information and second enablement information.

15. (canceled)

16. A non-transitory computer-readable storage medium storing a program that when executed by a computer causes the computer to execute a method according to claim 11.
